(19) United States
(12) Patent Application Publication
(10) Pub. No.: US 2005/0044478 A1
(43) Pub. Date: Feb. 24, 2005

(54) System and method for determining trust in the exchange of documents

(76) Inventors: Mir Sadek Ali, London (CA); Mir Adnan Ali, London (CA); Florian Vogt, Vancouver (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/643,152

(22) Filed: Aug. 19, 2003

(51) Int. Cl. G06F 15/00

(52) U.S. Cl. 715/500.1

(57) ABSTRACT

The present invention relates generally to qualifying trust in the exchange of electronic documents. During the course of an electronic document exchange, information on all document transmissions is recorded, separate from the documents themselves. A weight α is assigned to indicate the degree to which it is believed that a document based on another has in some way validated the earlier document. A total is calculated for each participant in the document exchange, based upon the number of times documents from each other participant are referenced. Each level of indirection in the counting process is weighted by a factor of α. The values calculated for each participant indicate the degree of trust placed with each participant by the others. The sum of these trust vectors, weighted by role weighting values, indicates the degree of trust placed in each participant. A reference counting procedure is performed across document references to determine for each participant which of their documents where referenced the most, taking into consideration levels of reference indirection and weighting factors, and thereby determining in which participants and documents the most trust is placed.

### FIELD OF THE INVENTION

The present invention relates generally to a system and method for determining trust in the exchange of documents.

### BACKGROUND OF THE INVENTION

In any system involving the exchange of documents, one of the challenges is tracking the document exchanges and ensuring they meet the standards of an appropriate audit process. An audit process may require that exchanged documents be analysed to ensure adherence to a protocol of document exchange, and have the appropriate sign-off and validation. Sign-off is applying a signature to a document, while validation is verification of the signature.

The underlying goal in the analysis of document exchange is to identify document exchanges that do not meet the protocol. The ability to do so reduces the risk and therefore liability due to flaws in the protocol. This type of analysis is useful in maximising effectiveness of auditor resources, and likewise is useful in preparing for scrutiny of the exchanged documents.

The present invention addresses the need for auditing document control and further, does it in real time. By targeting vulnerabilities within a protocol of document exchange in real time, rather than after the fact, up front costs are reduced and the auditing process is expedited.

### SUMMARY OF THE INVENTION

The present invention is directed to a method for determining trust in the exchange of documents, the method comprising the steps of:
a) recording meta-data on the exchange of each document; and
b) utilizing the meta-data to determine a degree of trust for each participant in the exchange of documents.

The meta-data comprises information to identify:
i) the sender of each document;
ii) the recipient of each document;
iii) the documents on which each document depends;
iv) the role of the sender of each document;
v) the role of the recipient of each document;
vi) the role of each document; and
vii) a digital signature for each document.

The utilizing step of this method comprises the steps of:
i) creating a document dependency vector D, based upon analyzing the documents sent by each participant;
ii) creating a recursive document vector DR, based on the results of step i);
iii) creating a trust vector TV for each participant based upon the results of step ii); and
iv) creating a global trust vector GTV based upon the results of step iii).

The present invention is also directed to a system for determining trust in the exchange of documents, the system comprising:
a) means for recording meta-data on the exchange of each document; and
b) means for utilizing the meta-data to determine a degree of trust for each participant in said exchange of documents.

Wherein the meta-data of the system comprises information to identify:
i) the sender of each document;
ii) the recipient of each document;
iii) the documents on which each document depends;
iv) the role of the sender of each document;
v) the role of the recipient of each document;
vi) the role of each document; and
vii) a digital signature for each document.
   wherein the means of utilizing comprises:
i) means for creating a document dependency vector D based upon an analysis of the documents sent by each participant,
ii) means for creating a recursive document vector DR, based upon dependency vector D;
iii) means for creating a trust vector TV, for each participant, based upon vector DR; and
iv) means for creating a global trust vector GTV based upon vector TV.

The present invention is also directed to a system for determining trust in the exchange of documents, the system comprising a network of general purpose computers, each computer containing;
a) a link protocol controller;
b) an input queue operatively connected to the link protocol controller;
c) an output queue operatively connected to the link protocol controller;
d) an interface response manager operatively connected to the output queue;
e) a query request engine operatively connected to the interface response manager and said input queue; and
f) one or more computing modules, each of the computing modules operatively connected to the query request engine.

The present invention if further directed to a computer readable medium containing instructions for determining trust in the exchange of documents comprising:
a) instructions for recording meta-data on the exchange of each document; and
b) instructions for utilizing said meta-data to determine a degree of trust for each participant in said exchange of documents.

The meta-data of the medium further comprises information to identify:
i) the sender of each document;
ii) the recipient of each document;
iii) the documents on which each document depends;
iv) the role of the sender of each document;
v) the role of the recipient of each document;
vi) the role of each document; and
vii) a digital signature for each document.

The instructions for utilizing comprising:
i) instructions for creating a document dependency vector D, based upon analyzing the documents sent by each participant;
ii) instructions for creating a recursive document vector DR, based on the results of i);
iii) instructions for creating a trust vector TV for each participant based upon the results of ii); and
iv) instructions for creating a global trust vector GTV based upon the results of iii).

### BRIEF DESCRIPTION OF THE DRAWINGS

For a better understanding of the present invention, and to show more clearly how it may be carried into effect, reference will now be made, by way of example, to the accompanying drawings which aid in understanding an embodiment of the present invention and in which:

FIG. 1 is a block diagram of the organizational roles of a clinical trial;

FIG. 2 is a flowchart of a documentation exchange process;

FIG. 3 is a block diagram of a document verification system;

FIG. 4 is a flowchart of the trust calculation process;

FIG. 5 is a block diagram illustrating document flow within a network; and

FIG. 6 is a block diagram of a trust analysis system.

### DETAILED DESCRIPTION OF THE INVENTION

Modern trust management systems typically incorporate some form of public-key infrastructure (PKI), and usually provide fine-grained permissions for users to perform certain actions based on the context of their request. An overview by Grandinson is presented in A Survey of Trust in Internet Applications, IEEE Communications Surveys, fourth quarter, 2000.

The specification of trust management systems is typically executed through formal algebraic systems specific to the trust model being used. Four examples of this type of approach are:

1. The PolicyMaker Trust Management system. This is discussed by M. Blaze, J. Feigenbaum, and M. Strauss, in Compliance Checkinq in the PolicyMaker Trust Management System, Proceedings of the Financial Cryptography '98 Conference, 254-274.

2. KeyNote. This system is discussed by M. Blaze, J. Feigenbaum and A. D. Keromytis in KeyNote: Trust Management for Publickey Infrastructures, Proceedings Cambridge 1998 Security Protocols International Workshop, 59-63. See also IETF RFC 2704.

3. REFREE: Rule-controlled Environment For Evaluation of Rules and Everything Else; as discussed by Yang-Hua Chan et al, in REFEREE: Trust Management for Web Applications, Computer Networks and ISDN Systems, 29(8-13):953-964, 1997; and

4. SULTAN: Simple Universal Logic-oriented Trust Analysis Notation. SULTAN is discussed by T. Grandison and M. Sloman in Specifying and Analysinq Trust for Internet Applications, in the Proceedings of the 2nd FIP conference on e-Commerce, e-Business, e-Government, I3e2002, Lisbon, Portugal, October 2002.

The above four mentioned systems are designed to evaluate trust prior to an event taking place. Examples of such events include:
a) downloading a web page; or
b) allowing an ecommerce transaction; or
c) posting a comment to a web site.

Such systems allow a system administrator to specify policy via algebraic relations or rules input by the administrator. In most of these systems, trust becomes a binary value relative to the operation to be performed: either the user is granted access or is denied.

These systems do not reflect all forms of trust of interest in document exchange systems, such as clinical trials. Most fundamentally, these systems maintain the notion of trust as being directed to whether a particular event (or transaction) should occur at all, based on the confidence placed in a user. In document exchanges systems such as those involving clinical trials, of equal interest is determining the amount of trust that has already been placed upon a participant in the trial.

Trust metrics are not well defined, and each system quantifies the concept in different ways. One may consider two types of trust, namely:

1. an assured reliance on the character, ability, strength, or truth of someone or something; and

2. one in which confidence is placed

The trust systems described above use definition 2, in that they determine whether a user qualifies to be “one in which confidence is placed”, that is, these systems indicate confidence in a user's future actions. This definition is well suited for an ecommerce scenario. However, in the exchange of documents we are often concerned with definition 1, rather than 2. This is because in systems such as a clinical trial there exist strongly enforced Standard Operating Procedures, and we are therefore also interested in detecting collusion and fraud, aside from preventing forgery, impersonation, spam, and other issues that affect online systems. We want to know “Who do we trust?” (or “Who are we trusting?”) rather than “Who can we trust?” in the future.

Other approaches to measuring trust include Advogato's trust metric, and Google's PageRank algorithm.

For the Advogato trust metric, see Ralph Levien and Alex Aiken in Attack-Resistant Trust Metrics for Public Key Certification, in the Proceedings of the 7th USENIX Security Symposium (Jan.), USENIX Association, Berkeley, Calif. 229-241 and http://www.advogato.org/. Advogato is designed to prevent spam or other abuse of a public infrastructure, such as a website allowing users to post articles and comments. The computation of the trust metric is performed relative to a “seed” of trusted accounts, who then certify other users at varying levels, such as Apprentice, Journeyer, or Master. The algorithm is expressed in terms of network flow operation, and possesses attack-resistant properties. However, this method is not directly applicable to auditing document exchange systems.

In the case of Google, the PageRank algorithm relies on certifying web pages by counting each link to a page as vote of confidence in that page. Web pages are the nodes in a trust network, and the confidence computation is performed as a theoretical random walk between pages. The eigenvector of the largest eigenvalue of a transition probability matrix of the Markov chain is the (naive) PageRank. This approach is also not directly applicable to trusted document exchange as it measures popularity as well as confidence in each node, although it also possesses many attack-resistant properties. An attack implies a user has constructed a set of web pages to “fool” Google's search relevancy algorithm, typically to cause a particular page to be ranked artificially high for a set of given search terms. While the exact algorithm used is proprietary, the basic approach is published by Lawrence Page et al, in The PageRank Citation Ranking: Brining Order to the Web, Technical Report, Stanford University 1998. Also, see U.S. Pat. No. 6,285,999.

By way of example we shall describe how the present invention may be utilized in a clinical trial situation for testing a new drug. It is not the intent of the inventors to restrict the present invention to the example provided, but rather that the example serves to illustrate how the present invention may be utilized in any document exchange system, for example in the exchange of legal, military or accounting documents.

Before a new drug may be legally used to treat disease in humans, it must be proven to be safe and effective. This is accomplished through the use of a pre-clinical and clinical trial process. The clinical trial process described herein is used by regulatory authorities in Canada, the U.S.A., Europe, and Japan.

Pre-clinical testing generally involves testing on human and animal cells within a laboratory, and live animals are often employed to determine if the drug is toxic. This process takes about two years. After the pre-clinical testing, four trial phases determine whether a particular drug arrives in the market. Table 1 illustrates the testing phases.

TABLE 1

| Phase | Determines | Patients | Duration |
|---|---|---|---|
| Pre-Clinical | Therapeutic Potential | 0 | 2 years |
| I | Safety | 10-35 | 1-2 years |
| II | Dosage | 50-200 | 2 years |
| III | Efficacy | 250-1000+ | 3-4 years. |
| IV | Side-effects | varies | varies |

The primary goal of the clinical trial process is to prove safety and efficacy of a new drug. A clinical trial process is defined by a trial protocol. The trial protocol defines:
a) the purpose of the trial;
b) the nature and composition of the new drug;
c) the patient population;
d) the number of clinic visits for each patient;
e) assessments of the patient including their reaction and the manner in which the assessments are conducted;
f) investigator's responsibilities beyond regulatory requirements, such as special reporting or treatments for adverse events;
g) oversight delegated to contract research organisations; and
h) statistical review to analyse the data collected in part e).

All communication within the clinical trial must follow the clinical protocol. The protocol is determined jointly by the sponsor (typically a pharmaceutical company), the regulatory authority (Ministry of Health in Canada, or the Food and Drug Administration in U.S.A), an institutional review board (IRB), and and/or an independent ethics committee (IEC). In practice the IRB/IEC are often combined. The members of the IRB/IEC are typically from public-health organisations such as hospitals and medical schools.

While a clinical protocol is determined prior to execution of a clinical trial phase, it may be amended at any time to deal with specific clinical trial circumstances. The IRB/IEC monitor the clinical trial progress as it executes. These bodies have authority to halt, cancel, or postpone a clinical trial in progress. A regulatory auditing process occurs between clinical trial phases. This auditing process determines whether the next phase takes place and what parameters must be tested. Examples of parameters would be heart rate and temperature.

Within a clinical trial there are a number of defined organisational roles, each of which may have several instances in a particular clinical trial. Examples of organizational roles would be: IRB/IEC, Clinical Research Organization (CRO), Clinical Investigator (Cl), and Site Management Organization (SMO).

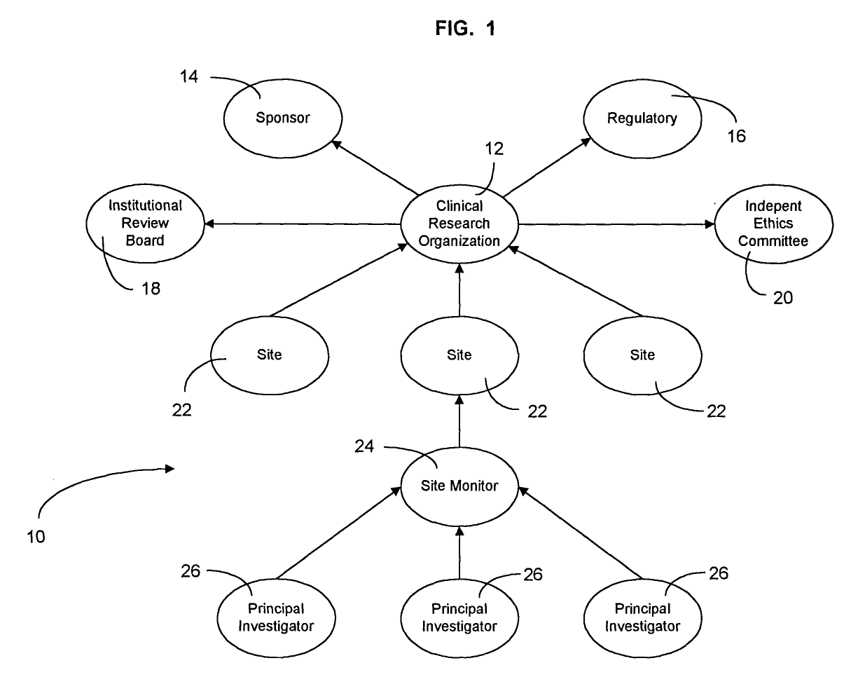

Referring now to FIG. 1 a block diagram of the organizational roles of a clinical trial is shown generally as 10. Clinical research organization 12 is responsible for conducting the clinical trial. Sponsor 14 would typically be a drug company. Regulatory 16 corresponds to the government regulatory bodies that oversee the clinical trial. Institutional Review Board (IRB) 18 and/or Independent Ethics Committee (IEC) 20 are independent bodies consisting of medical, scientific, and non-scientific members. The role of the IRB/IEC is to ensure the protection of the rights and safety of individuals involved in a trial. This is achieved by reviewing, approving, and providing continuing review of the trial protocol and amendments and of the methods used.

One or more sites 22 conduct the clinical trial and pass information to the Clinical Research Organization 12. A site 22 may have an associated site monitor 24, which collects clinical trial data from one or more principal investigators 26. The example of FIG. 1 is meant to be illustrative of only one possible configuration of the roles in a clinical trial.

Each clinical trial has many well defined processes. Each process defines the generation and maintenance of documents. Examples of processes include: Standard Operating Procedures (SOPs), Case Report Forms (CRFS, also known as “patient binders”), Adverse Events (notification of patient reactions potentially due to drug side-effects, e.g. a heart attack), and Data Clarification Requests. For each process, the trial protocol determines who must sign each document and to whom it must be sent (often in triplicate). A four phase clinical trial (see Table 1) may generate millions of documents that must somehow be audited to ensure public safety.

To enable a fully digital document chain, which would allow for an accelerated auditing process, the American FDA created legislation to allow electronic signatures to have the same legal force as traditional physical signatures. This legislation, Part 11 of Title 21 of the Code of Federal Regulation, also known as 21 CFR11, lays out a principles-based approach that is adaptable to varying clinical trial circumstances. Creating clinical trial protocols in compliance with 21CFR11 is a large-scale undertaking, and involves establishing audit trails, system security, validation, and electronic data capture SOPs. In short, 21CFR11 is applicable to clinical trials, enables the use of compliant electronic signatures, and provides criteria to determine predicate rules (any regulation requiring maintaining or submitting records to the FDA), compliance of computerised systems, and acceptable authentication protocols (passwords, public-key protocols), all specified using a principles-based approach.

As an example of the kind of principles involved, the trial protocol must be resistant to subversion by any one individual; however, trial protocol alone can't guarantee against collusion between individuals introducing incorrect or fraudulent data into a trial. During the trial, all data is reviewed by site monitors, the IRB/IEC, and bio-statisticians. Post-trial, checking for incorrect, incomplete, or fraudulent data is the responsibility of the bio-statisticians and regulatory auditors.

The auditing process is meant to detect fraud and collusion, compliance to protocol and legal regulations, and to ensure valid data. This is accomplished via spot checks, statistical data review, and experimental design techniques. Experimental design techniques are utilized to test several hypotheses at once, with the smallest number of data points, i.e. audit the smallest number of documents. Shortcomings of current approaches are that there is no global analysis, and no particular advantage is taken of the electronic data collection.

Cryptography schemes, such as public-key cryptography are employed by the present invention to provide secure exchange and signing of documents. In the example of clinical trials, regardless of the use of cryptographic signature systems the methods of “best practices”, known formally as Good Clinical Practice (GCP), Good Laboratory Practice (GLP), and Good Manufacturing Process (GMP) are employed to safeguard the validity and confidentiality of sensitive documents. However, these methods alone fail to indicate fraud and collusion, they also do not provide a means to focus limited auditing resources. They are meant to aid in the prevention of fraud, whereas detection is left to monitors, reviewers, and auditors.

In a document exchange system utilizing the present invention, any participant within an exchange of documents quantifies, via the present invention, the degree to which they rely upon the results of other participants. In the case of a document exchange requiring the content of the documents to be kept confidential, such as a clinical trial, an analysis of reliability is performed solely on meta-data. Examples of meta-data include: the user ID of the sender, the user id of the receiver, the role of the sender, the role of the receiver, a digital signature of the document and a list of documents upon which the sent document depends. By utilizing meta-data only for analysis, security cannot be compromised, as the contents of individual documents are not examined. In the case of a clinical trial, security is required to provide for double blinding, triple blinding and doctor-patient confidentiality. Such security serves to limit the information available to trial participants. Under double blinding, doctors do not know the identity of a patient or irrelevant medical history. They may not know if they are prescribing a placebo or one of several drugs under study. Triple blinding includes blinding such parties as data collectors and analysts so that only the Clinical Research Organization (CRO) can put together the entire study. This helps to eliminate bias due to preconceived notions of what is expected to occur. However, there are no such limitations on the study of meta-data, since private patient and blinded study data remains confidential.

Formal communication within a document exchange system is effected via signed documents transferred from senders to recipients. Throughout the course of the document exchange, each document sent can be considered from an information traffic perspective. The trust given to a participant may be determined without consulting specific information within a document, but rather from the meta-data describing the document. This ensures that the contents of a document may not be recovered directly or indirectly from this traffic-based perspective. The communication patterns of the participants of the document exchange are considered separately from the documents. This allows analysis of the document exchange, without revealing confidential information.

In the present invention, the terms of Table 2 characterize the meta-data of a document exchange.

TABLE 2

| Term | Definition |
|---|---|
| S(d) | Sender of a document d from a participant P |
| R(d) | Recipient of a document d from a participant P. |
| RS(d) | Role of a Sender of a document d from RP |
| RR(d) | Role of a Recipient of a document d from RP |
| RD(d) | Role of a Document d from RD |
| DS(d) | Digital Signature of a document d from a sender S |
| DD(d) | A list of documents upon which document d depends. |

The following example is provided to aid the reader in understanding the terms of Table 2.

P is a set of participants, say P={Sadek, Casey}

The roles of these participants and documents in the following example are:
RP=set of roles for participants={inspector, reviewer, commentator}
RD=set of roles for documents={report, comments}

In our example, Sadek sends a report L1 to Casey and Casey sends a reply L2 in response. In sending the report L1, Sadek has a role of “inspector” as does his peer Casey. However, in his reply L2, Casey is responding as a “reviewer”. In his reply to Casey on the contents of L2, Sadek has a role of “commentator”, Thus we have,
S(L1)=Sadek,
RS(L1)=inspector
R(L1)=Casey
RR(L1)=inspector
RD(L1)=report
S(L2)=Casey
RS(L2)=reviewer
R(L2)=Sadek
RR(L2)=commentator
RD(L2)=comments
DD(L2)={L1}

It is an implementation issue as to whether the sets that comprise the roles of participants and documents are defined ahead of time or are created as documents are generated. It is quite possible that there may be tens or hundreds of different roles for participants and documents.

The total set of documents exchanged can thus be characterised in a routing table RT, where each row of RT corresponds to a document d and contains entries for S, R, RS, RR, RD, DS and DD.

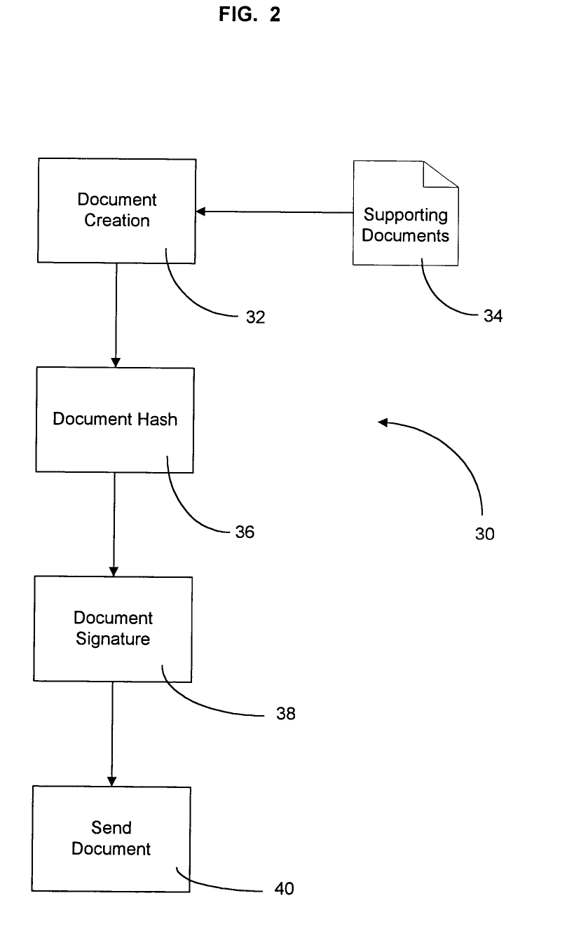

Referring now to FIG. 2, a flowchart of a documentation exchange process is shown generally as 30. At step 32 a participant creates a document which may have dependencies on previously signed and sent documents 34. At step 36 a document hash is computed based on the content of the document. Although the inventors make use of a hash algorithm, it is not their intent to restrict step 36 to a hash algorithm. Step 36 serves simply to reduce the content of the document prepared at step 32 prior to step 39. At step 38 the document signature is computed by making use of the participant's private cryptographic key. Although the present invention suggests the use of Private Key Infrastructure (PKI) at step 38, any form of encoding that will uniquely identify the result of step 38 will is also acceptable. At step 40 the document is sent to the intended recipient by secure electronic means or possibly by a courier service, also at step 40 the digital signature and other information regarding the transmission is stored in routing table RT.

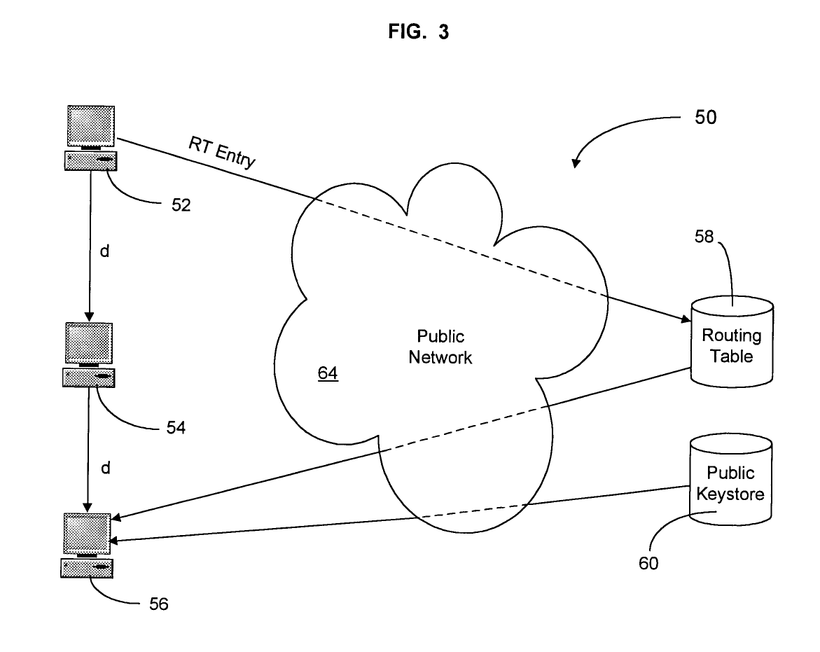

Referring now to FIG. 3, a block diagram of a document verification system is shown generally as 50. A participant utilizing a computer 52 sends a document d to a participant utilizing a computer 54. The participant utilizing computer 54 then forwards document d to a participant utilizing computer 56. The participant utilizing computer 56 then verifies the signature of document d by querying routing table 58 and public keystore 60. Routing table 58 and public keystore 60 are databases residing on one or more computers. Public keystore 60 contains a public key for the participant utilizing computer 52 which will allow the participant utilizing computer 56 to verify that document d is the original document d created by the participant utilizing computer 52. Only meta-data about the document d is sent over network 64. Network 64 may be any form of network, such as the Internet. Typically the document would be confidential and is thus not transmitted over public network 64 but rather a private network connecting computers 52, 54 and 56. Either or both of routing Table 58 and Public Keystore 60 may reside within the private network connecting computers 52, 54 and 56 if desired. Although computers 52, 54 and 56 are shown as separate devices, the same functionality of document exchange may be implemented on a single computer for multiple users.

Each document exchange between participants has the following characteristics:
a) each participant (sender or recipient) i has a participant ID number
b) each participant role has a role id RP(role);
c) each participant role has a given numerical weight WRP(RP(role)), the default being 1;
d) each document role has a document role ID number RD(document role);
e) each document has a role, with a given a numerical weight WRD(RD (document role)), the default being 1;
f) each document d has a document ID number DID(d);
g) There are NP participants so that i is in [1::NP];
h) There are ND documents so that d is in [1::ND]; and
i) There is a verification weight, which is the weight that a document in one level in the trial chain holds, between zero and one. For example, if the verification for each document is absolutely trusted, the verification weight would have a value of one. In contrast if the number of times a document is verified is to be entirely discounted, the verification value would be zero. So, set we set:
   α=1−(the verification weight)

Each participant is a node in the trust network. Each communication between nodes forms an edge in the network.

Counting the number of communications between all nodes provides a traffic network, T[i, j]. A document dependency matrix D is determined by recursively counting the documents which each document refers to in the traffic network, T[i, j]. However, we wish to determine trust in specific parties in the documentation exchange, so we focus first on determining the dependence on each node. The amount of trust for a particular node is a function of the number of dependencies on that node.

This form of trust is relative to the number of documents based on that node's output. A global trust matrix GTVP, indicates the degree of trust placed with each node.

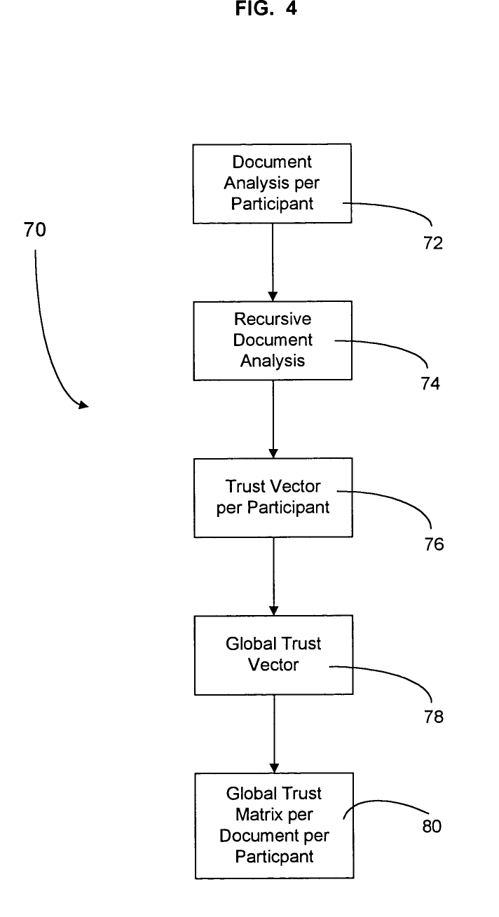

To aid the reader in understanding how trust is calculated we refer now to FIG. 4, a flowchart of the trust calculation process, shown generally as 70.

Beginning at step 72, document analysis per participant is performed. This consists of forming a document dependency vector D(d) of dimension NP At this step, for a document d, the entries in RT(d).DD, are examined and for each dependant document the value of one is added to the element of D(d) corresponding to the sender of the document.

Moving on to step 74, recursive document analysis is performed. This consists of forming a recursive document vector DR(d) for each document d, of dimension NP, initially setting DR(d):=D(d). Next a lookup is made in table RT for the row corresponding to document d and recursively selecting each document upon which the current document depends. Setting d′=R(d).DD and adding the vector D(d′) to the recursive sum DR(d) weighted by the depth of recursion n, yields:
DR(d):=DR(d)+αⁿ·D(d′)
for all documents having dependencies. The vector DR provides the number of references each document is based on from each participant, weighted by the number of verification steps performed.

Moving next to step 76 a calculation is made of the trust vector per participant. This is done by creating a trust vector TV(p) for each participant. TV(p) is calculated by summing for each participant, the vectors DR(d) weighted by WRD(d) for document d of which p is the sender. In other words where RT(d):S==p. The vector TV quantifies for each participant the degree of trust imbued in the participant based upon the documents they have sent.

Moving next to step 78 a global trust vector GTV of dimension NP is calculated. This is done by summing the trust vectors TV(p) for each participant, over all participants. The summation to create entry GTV(p) is then weighted by the role weight of the participant WRP (p). The vector GTV provides an overall measure of the amount of trust placed upon the output of each participant.

Moving next to step 80, a global trust matrix per document per participant (GTVP) is calculated. This is achieved by first creating a most used document vector MU of dimension ND. For each dependency in RT(d).DD a value of one is added to the associated document index in MU

For each entry added to MU its dependencies are recursively enumerated by using the DD column in the R table, weighting each further level of recursion with the weight verification factor α. The vector MU provides the trust given to each document.

A global trust matrix per document per participant GTVP is of dimension NP by ND and is formed by looking up for each row in RT the original sender and setting GTVP(d, S) equal to MU(d). The matrix GTVP gives each participant a relative ranking of the trust given to each document sent by that participant.

To summarize, the method of the present invention, during the course of an electronic document exchange, uses only the meta-data regarding a document exchange in its trust calculations. This meta-data is stored separate from the documents themselves. Meta-data includes: sender, sender's role, recipient, recipient's role, document ID, document signature, document role, and a list of previous documents that the document depends upon. When a participant receives a document and produces another document referring to the received document, there is a presumption of the validity of the received document. A weight α is assigned to indicate the degree to which it is believed that a document based on another has in some way verified the earlier document. The value of α is between zero and one. If the verification of each document is absolutely trusted, the value is one. If it is desired to entirely discount the number of times a document is verified, a value of zero is chosen. Experimentation by the inventors indicates that a reasonable default is to set α=0.5.

Weights are also assigned to indicate the relative importance of the various role of participants. These weights may take any value, with a default of one. Basically these role weights serve to target the trust within a given set of participants. For a global analysis, these should be set to one. For each participant, a total is calculated, for the number of times documents from each other participant are referenced. Each level of indirection in the counting process is weighted by α. The values calculated for each participant indicate the degree of trust placed with each participant by the others. The sum of these trust vectors, weighted by the role weighting values, indicates the degree of trust overall placed in each participant.

Finally a reference counting procedure is performed across documents to determine for each participant, which documents of theirs were referenced the most, and therefore the most trust was placed in.

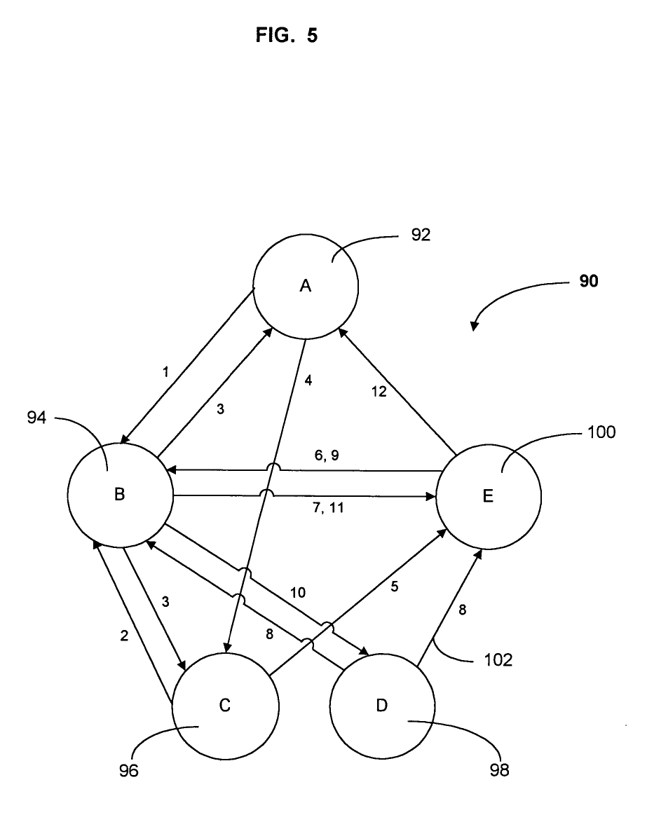

To better illustrate the calculations conducted in process 70, we now refer to FIG. 5 where a block diagram illustrating document flow within a network is shown generally as 90. Each node (A, B, C, D, and E) or (92, 94, 96, 98 and 100) has connected to it one or two directed edges, for example edge 102. In FIG. 5 each edge has associated with it one or more document identification numbers. In the case of edge 102, the document identification number is eight, indicating that node 98 sent document eight to node 100. In a typical implementation each node would be a participant utilizing a computer on a computer network. The network of FIG. 5 may be either real or virtual. In a real network, each node is a separate computing device, connected to the others by a physical communications network. In a virtual network, all of the nodes may reside on a single computer and communicate with each other without the need of an external communications network. As can be appreciated a combination of either is possible, where several nodes reside on one computer and the rest on one or more separate computers. Table 3 summarizes the routing information shown in FIG. 5.

TABLE 3
Routing Information from FIG. 5

| Transmit | Document | | | Document |
|---|---|---|---|---|
| ID | ID | From | To | Dependencies |
| 1 | 1 | A | B | |
| 2 | 2 | C | B | |
| 3 | 3 | B | A | 1, 2 |
| 4 | 3 | B | C | 1, 2 |
| 5 | 4 | A | C | 3 |
| 6 | 5 | C | E | 4 |
| 7 | 6 | E | B | 5 |
| 8 | 7 | B | E | 6, 1, 2 |
| 9 | 8 | D | E | |
| 10 | 9 | E | B | 8 |
| 11 | 10 | B | D | 9 |
| 12 | 8 | D | B | |
| 13 | 11 | B | E | 8, 10, 5 |
| 14 | 12 | E | A | 11, 7 |

From Table 3 we can compute the document dependencies and the recursive document dependencies.

For each document, we first count the number of dependencies from each participant for that document, as indicated in step 72 of FIG. 4. For example, document number 12 depends on two documents, 11, and 7, originating from B (node 94).

This analysis provides us with the following document dependency vectors:

| | A | B | C | D | E |
|---|---|---|---|---|---|
| D(1) = | [0 | 0 | 0 | 0 | 0] |
| D(2) = | [0 | 0 | 0 | 0 | 0] |
| D(3) = | [1 | 0 | 1 | 0 | 0] |
| D(4) = | [0 | 1 | 0 | 0 | 0] |
| D(5) = | [1 | 0 | 0 | 0 | 0] |
| D(6) = | [0 | 0 | 1 | 0 | 0] |
| D(7) = | [1 | 0 | 1 | 0 | 1] |
| D(8) = | [0 | 0 | 0 | 0 | 0] |
| D(9) = | [0 | 0 | 0 | 1 | 0] |
| D(10) = | [0 | 0 | 0 | 0 | 1] |
| D(11) = | [0 | 1 | 1 | 1 | 0] |
| D(12) = | [0 | 2 | 0 | 0 | 1] |

Next (step 74 of FIG. 4) the recursive document dependencies are computed, where each recursive dependency is the sum of its dependencies plus α times that document's recursive dependencies. Thus we have:

$$DR ( 1 ) = D ( 1 )$$

$$DR ( 2 ) = D ( 2 )$$

$$\begin{matrix}DR ( 3 ) = D ( 3 ) + α ( DR ( 1 ) + DR ( 2 ) ) \\ = D ( 3 ) + α ( D ( 1 ) + D ( 2 ) )\end{matrix}$$

$$\begin{matrix}DR ( 4 ) = D ( 4 ) + α ( DR ( 3 ) ) \\ = D ( 4 ) + α D ( 3 ) + {α}^{2} ( D ( 1 ) + D ( 2 ) )\end{matrix}$$

$$\begin{matrix}DR ( 5 ) = D ( 5 ) + α ( DR ( 4 ) ) \\ = D ( 5 ) + α D ( 4 ) + {α}^{2} D ( 3 ) + {α}^{3} ( D ( 1 ) + D ( 2 ) )\end{matrix}$$

$$\begin{matrix}DR ( 6 ) = D ( 6 ) + α ( DR ( 5 ) ) \\ = D ( 6 ) + α D ( 5 ) + {α}^{2} D ( 4 ) + {α}^{3} D ( 3 ) + {α}^{4} ( D ( 1 ) + D ( 2 ) )\end{matrix}$$

$$\begin{matrix}DR ( 7 ) = D ( 7 ) + α ( DR ( 6 ) + DR ( 1 ) + DR ( 2 ) ) \\ = D ( 7 ) + α ( D ( 6 ) + D ( 1 ) + D ( 2 ) ) + {α}^{2} D ( 5 ) + {α}^{3} D ( 4 ) + \\ {α}^{4} D ( 3 ) + {α}^{5} ( D ( 1 ) + D ( 2 ) )\end{matrix}$$

$$DR ( 8 ) = D ( 8 )$$

$$\begin{matrix}DR ( 9 ) = D ( 9 ) + α ( DR ( 8 ) ) \\ = D ( 9 ) + α D ( 8 )\end{matrix}$$

$$\begin{matrix}DR ( 10 ) = D ( 10 ) + α ( DR ( 9 ) ) \\ = D ( 10 ) + α D ( 9 ) + {α}^{2} ( D ( 8 )\end{matrix}$$

$$\begin{matrix}DR ( 11 ) = D ( 11 ) + α ( DR ( 8 ) + DR ( 10 ) + DR ( 5 ) ) \\ = D ( 11 ) + α ( D ( 8 ) + D ( 10 ) + D ( 5 ) ) + {α}^{2} ( D ( 9 ) + \\ D ( 4 ) ) + {α}^{3} ( D ( 8 ) + D ( 3 ) ) + {α}^{4} ( D ( 1 ) + D ( 2 ) )\end{matrix}$$

$$\begin{matrix}DR ( 12 ) = D ( 12 ) + α ( DR ( 11 ) + DR ( 7 ) ) \\ = D ( 12 ) + α ( D ( 11 ) + DR ( 7 ) ) + \\ {α}^{2} ( D ( 8 ) + D ( 10 ) + D ( 5 ) + D ( 6 ) + D ( 1 ) + D ( 2 ) ) + \\ {α}^{3} ( D ( 9 ) + D ( 4 ) + D ( 5 ) ) + \\ {α}^{4} ( D ( 8 ) + D ( 3 ) + D ( 4 ) ) + \\ {α}^{5} ( D ( 1 ) + D ( 2 ) + D ( 3 ) ) + \\ {α}^{6} ( D ( 1 ) + D ( 2 ) )\end{matrix}$$

Computing the values of DR, with α=½, yields the following:

| | A | B | C | D | E |
|---|---|---|---|---|---|
| DR(1) = | [0 | 0 | 0 | 0 | 0] |
| DR(2) = | [0 | 0 | 0 | 0 | 0] |
| DR(3) = | [1 | 0 | 1 | 0 | 0] |
| DR(4) = | [1/2 | 1 | 1/2 | 0 | 0] |
| DR(5) = | [5/4 | 1/2 | 1/4 | 0 | 0] |
| DR(6) = | [5/8 | 1/4 | 9/8 | 0 | 0] |
| DR(7) = | [21/16 | 1/8 | 25/16 | 0 | 1] |
| DR(8) = | [0 | 0 | 0 | 0 | 0] |
| DR(9) = | [0 | 0 | 0 | 1 | 0] |
| DR(10) = | [0 | 0 | 0 | 1/2 | 1] |
| DR(11) = | [5/8 | 5/4 | 9/8 | 5/4 | 1] |
| DR(12) = | [47/32 | 43/16 | 29/32 | 9/8 | 7/4] |

Next the value the trust vector per participant (TV(p)) is calculated. As discussed above with reference to step 76 of FIG. 4. TV(p) is calculated by summing for each participant, the vectors DR(d) weighted by WRD(d) for document d of which p is the sender. In other words where RT(d):S==p. The vector TV quantifies for each participant the degree of trust imbued in the participant based upon the documents they have sent.

By way of example assume participants A and B have a role of “technician” and let WRP(technician) be set to 0.25. Further, let documents 11 and 12 have a document role of “adverse event report”, and let WRD(adverse event report) be set to 2.0. Let all other WRD and WRP values being set to 1.0. Thus we have:

$$\begin{matrix}TV ( A ) = DR ( 1 ) + DR ( 4 ) \\ = [ 1 / 2 , 1 , 1 / 2 , 0 , 0 ] \\ TV ( B ) = DR ( 3 ) + DR ( 7 ) + DR ( 10 ) + {2}^{*} DR ( 11 ) \\ = [ 57 / 16 , 21 / 8 , 77 / 16 , 3 , 4 ] \\ TV ( C ) = DR ( 2 ) + DR ( 5 ) \\ = [ 5 / 4 , 1 / 2 , 1 / 4 , 0 , 0 ] \\ TV ( D ) = DR ( 8 ) \\ = [ 0 , 0 , 0 , 0 , 0 ] \\ TV ( E ) = DR ( 6 ) + DR ( 9 ) + {2}^{*} DR ( 12 ) \\ = [ 57 / 16 , 45 / 8 , 47 / 16 , 9 / 4 , 7 / 2 ]\end{matrix}$$

Next, applying the weights of WRP(technician) of ¼ to the roles of A and B we have:

$$\begin{matrix}GTV = ( 1 / 4 ) * TV ( A ) + ( 1 / 4 ) * TV ( B ) + TV ( C ) + TV ( D ) + TV ( E ) \\ = [ 373 / 64 , 225 / 32 , 289 / 64 , 3 , 11 / 2 ] \\ = [ 5.8 , 7.0 , 4.5 , 3.0 , 5.5 ]\end{matrix}$$

This example calculation of GTV indicates that in order of most trusted to least trusted participants, the order would be B, A, E, C, D.

A more detailed analysis could go on, in a similar fashion, to compute the trust placed by each participant within each document, to form a global trust matrix GTVP.

Traffic matrix T[i, j] gives an indication of grouping, so that highly connected nodes may be coalesced into single nodes to perform a similar analysis site by site. In coalescing, each site may have multiple participants that are treated as one participant for the purpose of trust analysis. There are a number of methods that can be used to coalesce nodes. For example the EM (Expectation Maximization Algorithm) as discussed by A. P. Dempster, N. M. Laird, and D. B. Rubin in Maximum Likelihood of Incomplete Data via the EM Algorithm, Journal of the Royal Statistical Society, Series B, 34:1-38, 1977.

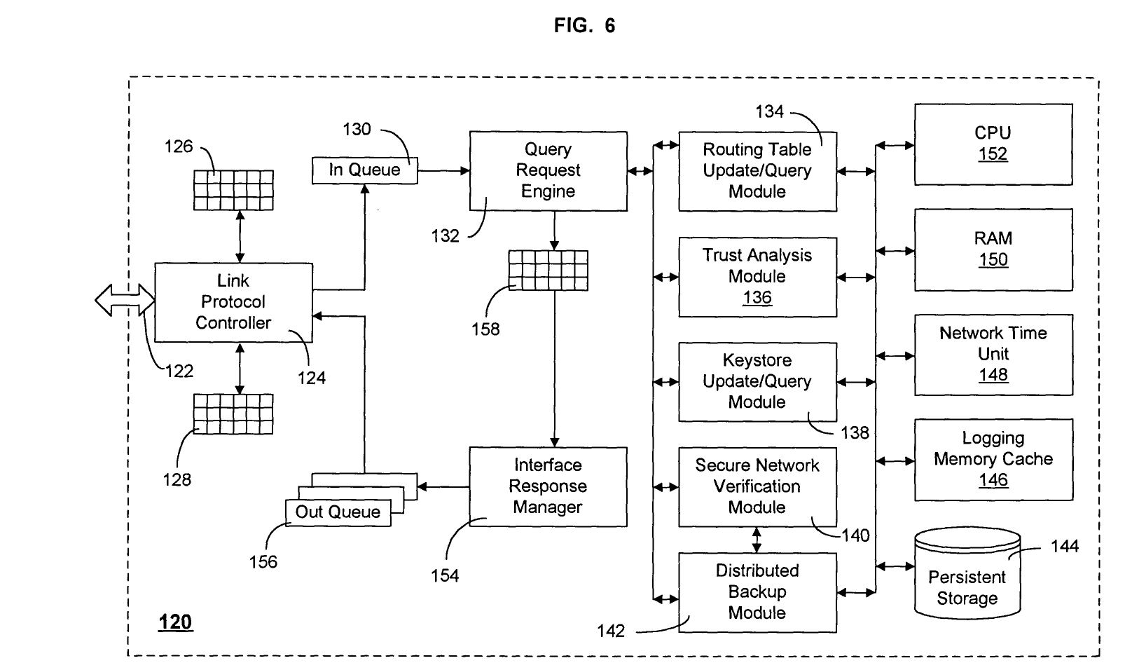

Referring now to FIG. 6 a block diagram of a trust analysis system is shown as 120. System 120 may be a standalone system or may have multiple copies or “peers”. The advantage of having peers is to provide redundancy should a single system 120 fail. System 120 manages and reports on the data collected during document exchange between nodes of a trust network. The topology of the network that utilizes system 120 is a hardware network, for example comprising the user computers of FIG. 3 and other systems 120. This hardware network should not be confused with the trust network example of FIG. 5. System 120 communicates with users and other systems 120 through communication link 122. Link protocol controller 124 receives and sends information through link 122. Link protocol controller 124 would typically make use of the Ethernet protocol, but may make use of other protocols as required. To aid in communication with other devices, controller 124 makes use of interface management table 126 and network address table 128. Interface management table 126 contains the information required by protocol controller 124 to maintain a connection. Network address table 128 contains the network address information of nodes that controller 124 is aware of. Table 128 provides two functions in that it provides controller 124 with the address information needed to send a message and an indication of which incoming messages to ignore.

Link protocol controller 124 places messages intended for system 120 in input queue 130. Each message placed in queue 130 is time stamped, based upon the sender time of the message, by system 120. Query request engine 132 reads input queue 130 and acts upon each message. Messages may be of a variety of types including: query requests, query updates, backup requests and system time updates. Upon receipt of a message query request engine 132 reformats the message as needed and forwards the reformatted message to an appropriate module. In the example of FIG. 6 there are five modules, each handles a different type of message.

Routing table update/query module 134 handles messages that are directed to obtaining trust calculations as well as updates and queries of the contents of routing table 58 (see FIG. 3). In the case of a message requesting a trust calculation, module 134 forwards the message to trust analysis module 136. Trust analysis module performs the calculations required and returns the result to module 134, which in turn forwards the result to query request engine 132. The result is then stored by query request engine 132 in query routing table 158. Alternatively, a message may be formatted so that it passes directly from query request engine 132 to trust analysis module 136.

Routing table update/query module 132 may also receive messages that update or query the contents of routing table 58. Such messages are handled by module 134 and the results returned to query request engine 132 and stored in table 158 to be forwarded to the originator of the message.

Some messages received by query request engine 132 may require verification of a key stored in public keystore 60 (see FIG. 3). In order to improve performance, system 120 may locally store the information contained in keystore 60. However, such information, such as a public key, may have an expiration date. Should the information not be expired, keystore update/query module 138 may provide the information to the requester. Should the requested information be expired, module 138 will request an update from keystore 60. In the case of an update, the locally stored information will be updated and transmitted to the requestor.

Secure network verification module 140 ensures that the network traffic distributed to each distributed backup module 142 is kept confidential. Confidentiality is maintained through the use of a protocol such as Secure Socket Layer (SSL). Further through the use of trusted server services such as fixed IP schemes or Virtual Private Networks (VPN), attacks such as the “man in the middle” are unlikely. As a result, persistent storage 144 can trust messages from distributed backup module 142. Secure network verification module 140 provides the services for distributed backup module 142 to trust the content of messages, the sender and the receiver. The services provided by module 140 ensure that the messages sent from query request engine 132 to distributed backup module 142 are genuine.

Distributed backup module 142 confirms that the locally stored data in persistent storage 144 is the must current across the network. Distributed backup module 142 makes use of a regular backup protocol such as rsync to ensure that all persistent data stored on each system 120 in persistent storage 144 is the same. This entails the broadcast of synchronization information between each distributed backup module 142. For example, if a message in the form of a query arrives, the timestamp of the message is checked. If the message is later than the current date of the information stored in persistent storage 144, the information is updated before a response is sent to the requester. Asynchronously the new information, that has been updated to persistent storage 144 and the nature of the update is sent through distributed backup module 142 as a request to synchronize each distributed backup module 142 in the network. The request is maintained on the originating distributed backup module 142 until each module 142 has confirmed that it has received the request and has processed the request in its related persistent storage 144.

Persistent storage 144 provides a place to permanently store information stored within tables 126 and 128 as well as any locally stored information contained within routing table 58 or public keystor3e 60 (See FIG. 3) and the contents of requests received from the query request engine. Each persistent storage 144 will be accompanied on the network with one or more distributed backup modules 142.

Logging memory cache 146 records all logical events for system 120. Logical events include all queries to system 120, all updates to locally store data, and system events such as the time of any backups and time corrections.

Network Time Unit (NTU) 148, maintains the local time used by system 120 and synchronizes it with other systems 120 through the use of a facility such as the Network Time Protocol (NTP).

Central Processing Unit (CPU) 152 is a computer processor, which provides the central processing for system 120. Random Access memory (RAM) 154 provides temporary memory for the use of CPU 152 and modules within system 120.

Once a response to a message has been formulated, the result is stored in query routing table 158. Interface response manager 154 reads the contents of table 158 and creates an outgoing message in response to the original incoming message. An output queue 156 is created for each originator of an incoming message. The response to be sent to the originator is then sent to their specific queue. Link protocol controller 124 handles the scheduling of the responses stored in each output queue 156.

In summary, the present invention provides the following:
a) the process is automatic, and depends only on information collected by default within electronic document exchange;
b) it does not require or expose documents to a participant;
c) it quantifies trust placed in individual participants based upon the documents they exchange; and
d) it is robust against dynamic changes in the underlying document exchange protocol.

It is the intent of the inventors that the term “document” includes all forms of information including digital files and database records. The present invention may be used to evaluate trust in the exchange of information in any form within a computer based network.

Although the present invention has been described in some aspects as being a software based invention, it is the intent of the inventor to include computer readable forms of the invention. Computer readable forms being any stored format that may be read by a computing device.

Although the invention has been described with reference to certain specific embodiments, various modifications thereof will be apparent to those skilled in the art without departing from the spirit and scope of the invention as outlined in the claims appended hereto.

1. A method of determining trust in the exchange of documents, said method comprising the steps of:
a) recording meta-data on the exchange of each document; and
b) utilizing said meta-data to determine a degree of trust for each participant in said exchange of documents.

2. The method of claim 1 wherein said meta-data comprises information to identify:
i) the sender of each document;
ii) the recipient of each document; and
iii) the documents on which each document depends.

3. The method of claim 2 wherein said meta-data further comprises information to identify:
iv) the role of the sender of each document;
v) the role of the recipient of each document; and
vi) the role of each document.

4. The method of claim 3 wherein said meta-data further comprises a digital signature for each document.

5. The method of claim 1 wherein said utilizing comprises the steps of:
i) creating a document dependency vector D, based upon analyzing the documents sent by each participant;
ii) creating a recursive document vector DR, based on the results of step i);
iii) creating a trust vector TV for each participant based upon the results of step ii); and
iv) creating a global trust vector GTV based upon the results of step iii).

6. The method of claim 5 further comprising the step of:
v) creating a global trust matrix per document per individual, GTVP.

7. A system for determining trust in the exchange of documents, said system comprising:
a) means for recording meta-data on the exchange of each document; and
b) means for utilizing said meta-data to determine a degree of trust for each participant in said exchange of documents.

8. The system of claim 7 wherein said meta-data comprises information to identify:
i) the sender of each document;
ii) the recipient of each document; and
iii) the documents on which each document depends.

9. The system of claim 8 wherein said meta-data further comprises information to identify:
iv) the role of the sender of each document;
v) the role of the recipient of each document; and
vi) the role of each document.

10. The system of claim 9 wherein said meta-data further comprises a digital signature for each document.

11. The system of claim 7 wherein said means of utilizing comprises:
i) means for creating a document dependency vector D based upon an analysis of the documents sent by each participant,
ii) means for creating a recursive document vector DR, based upon dependency vector D;
iii) means for creating a trust vector TV, for each participant, based upon vector DR; and
iv) means for creating a global trust vector GTV based upon vector TV.

12. The system of claim 11 further comprising;
v) means for creating a global trust matrix per document per individual, GTVP.

13. A system for determining trust in the exchange of documents, said system comprising a network of general purpose computers, each computer containing;
a) a link protocol controller;
b) an input queue operatively connected to said link protocol controller;
c) an output queue operatively connected to said link protocol controller;
d) an interface response manager operatively connected to said output queue;
e) a query request engine operatively connected to said interface response manager and said input queue; and
f) one or more computing modules, each of said computing modules operatively connected to said query request engine.

14. The system of claim 13 wherein said one or more computing modules comprises:
g) a routing table update/query module;
h) a keystore update/query module;
i) a trust analysis module;
j) a secure network verification module; and
k) a distributed backup module.

15. The system of claim 14 further comprising a network time unit operatively connected to one or more of said one or more computing modules.

16. A computer readable medium containing instructions for determining trust in the exchange of documents comprising:
a) instructions for recording meta-data on the exchange of each document; and
b) instructions for utilizing said meta-data to determine a degree of trust for each participant in said exchange of documents.

17. The medium of claim 16 wherein said meta-data comprises information to identify:
i) the sender of each document;
ii) the recipient of each document; and
iii) the documents on which each document depends.

18. The medium of claim 17 wherein said meta-data further comprises information to identify:
iv) the role of the sender of each document;
v) the role of the recipient of each document; and
vi) the role of each document.

19. The medium of claim 18 wherein said meta-data further comprises a digital signature for each document.

20. The medium of claim 16 wherein said instructions for utilizing comprises:
i) instructions for creating a document dependency vector D, based upon analyzing the documents sent by each participant;
ii) instructions for creating a recursive document vector DR, based on the results of i);
iii) instructions for creating a trust vector TV for each participant based upon the results of ii); and
iv) instructions for creating a global trust vector GTV based upon the results of iii).

21. The medium of claim 20 further comprising instructions for creating a global trust matrix per document per individual, GTVP.
